(19) United States
(12) Patent Application Publication
(10) Pub. No.: US 2013/0007882 A1
(43) Pub. Date: Jan. 3, 2013

(54) METHODS OF DETECTING AND REMOVING BIDIRECTIONAL NETWORK TRAFFIC MALWARE

(75) Inventors: Ganesh Devarajan, Phoenix, AZ (US); Russell Herbelin, Mesa, AZ (US); Don Lebert, Phoenix, AZ (US); Todd Redfoot, Phoenix, AZ (US); Neil Warner, Mayer, AZ (US)

(73) Assignee: THE GO DADDY GROUP, INC., Scottsdale, AZ (US)

(21) Appl. No.: 13/249,051

(22) Filed: Sep. 29, 2011

Related U.S. Application Data
(63) Continuation-in-part of application No. 13/170,535, filed on Jun. 28, 2011.
Application No. 13/170,535 is a continuation-in-part of application No. 13/170,514, filed on Jun. 28, 2011.

(51) Int. Cl. G06F 21/20

(52) U.S. Cl. 726/24

(57) ABSTRACT

An exemplary method for bi-directional detection and removal of network traffic malware may comprise receiving a request for website content, removing any server-directed malware from the content request, transmitting the scrubbed content request to the website's hosting server, receiving the responsive website content, removing and client-directed malware from the content, and transmitting the scrubbed content to the requesting client.

### CROSS REFERENCE TO RELATED PATENT APPLICATIONS

This patent application is a continuation-in-part of U.S. patent application Ser. No. 13/170,535 entitled: “NETWORK RESOURCE ADDRESS REPUTATION SERVICE” and U.S. patent application Ser. No. 13/170,514 entitled: “SYSTEMS PROVIDING A NETWORK RESOURCE ADDRESS REPUTATION SERVICE,” both being filed on Jun. 28, 2011, assigned to The Go Daddy Group, Inc., and incorporated hereby in entirety by reference.

This patent application also is related to U.S. patent application Ser. No. ______ entitled: “SYSTEMS FOR BI-DIRECTIONAL NETWORK TRAFFIC MALWARE DETECTION AND REMOVAL” concurrently filed herewith and also assigned to The Go Daddy Group, Inc.

### FIELD OF THE INVENTION

The present inventions generally relate to network security and, more particularly, systems, methods, and other tools for providing a network resource address reputation service and systems and methods for bi-directional detection and removal of network traffic malware.

### SUMMARY OF THE INVENTION

An example embodiment of a system for providing a network resource address reputation service may comprise one or more network security device (communicatively coupled to a network) storing a plurality of event signatures and being configured to determine whether an event associated with a network resource having a network resource address matches one or more of the plurality of event signatures, a first malicious network resource address database (communicatively coupled to the network) storing a plurality of malicious network resource addresses determined to be malicious by one or more external feeds, and one or more server (communicatively coupled to the network) configured to (upon a determination that the event matches one or more of the plurality of event signatures) generate a reputation score for the network resource address and determine whether the network resource address is present in the first malicious network resource address database. If the network resource address is present in the external malicious network resource address database, the one or more server may modify the reputation score to indicate a more negative reputation for the network resource address and store (in a second malicious network resource address database communicatively coupled to the network) the network resource address in association with the reputation score.

An example embodiment of a method of providing a network resource address reputation service may comprise the steps of determining whether an event associated with a network resource address matches one or more of a plurality of event signatures in one or more network security device. If the event associated with the network resource address matches one or more of the plurality of event signatures, the example method further may comprise the steps of generating a reputation score for the network resource address and determining whether the network resource address is present in a first malicious network resource address database. If the network resource address is not present in the first malicious network resource address database, the method further may comprise the step of storing, in a second malicious network resource address database, the network resource address in association with the reputation score. If the network resource address is present in the first malicious network resource address database, the method further may comprise the steps of modifying the reputation score to indicate a more negative reputation for the network resource address and storing, in a second malicious network resource address database, the network resource address in association with the reputation score.

An exemplary bi-directional network traffic malware detection and removal system may comprise a scrubbing center running one or more server computer communicatively coupled to a network configured to receive a request for website content, remove any server-directed malware from the content request, transmit the scrubbed content request to the website's hosting server, receive the responsive website content, remove and client-directed malware from the content, and transmit the scrubbed content to the requesting client.

An exemplary method for bi-directional detection and removal of network traffic malware may comprise receiving a request for website content, removing any server-directed malware from the content request, transmitting the scrubbed content request to the website's hosting server, receiving the responsive website content, removing and client-directed malware from the content, and transmitting the scrubbed content to the requesting client.

The above features and advantages of the present inventions will be better understood from the following detailed description taken in conjunction with the accompanying drawings.

### BRIEF DESCRIPTION OF THE DRAWINGS

FIG. 1 illustrates a possible embodiment of a system for providing a network resource address reputation service.

FIG. 2 illustrates a possible embodiment of a system for providing a network resource address reputation service.

FIG. 3 illustrates a possible embodiment of a system for providing a network resource address reputation service.

FIG. 4 is a flow diagram illustrating a possible embodiment of a method of providing a network resource address reputation service.

FIG. 5 is a flow diagram illustrating a possible embodiment of a method of providing a network resource address reputation service.

FIG. 6 is a flow diagram illustrating a possible embodiment of a method of generating a reputation score for a network resource address associated with an event matching a signature in a network security device.

FIG. 7 is a flow diagram illustrating a possible embodiment of a method of generating a reputation score for a network resource address associated with an event matching a signature in a network security device.

FIG. 8 is a flow diagram illustrating a possible embodiment of a method of providing a network resource address reputation service.

FIG. 9 illustrates a possible embodiment of a bi-directional network traffic malware detection and removal system.

FIG. 10 is a flow diagram illustrating a possible embodiment of a method for bi-directional detection and removal of network traffic malware.

FIG. 11 is a flow diagram illustrating a possible embodiment of a method for bi-directional detection and removal of network traffic malware.

### DETAILED DESCRIPTION

The present inventions will now be discussed in detail with regard to the attached drawing figures, which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related webpages. Menus and links may be used to move between different webpages within the website or to move to a different website as is known in the art. The interconnectivity of webpages enabled by the Internet can make it difficult for Internet users to tell where one website ends and another begins. Websites may be created using HyperText Markup Language (HTML) to generate a standard set of tags that define how the webpages for the website are to be displayed. Such websites may comprise a collection of HTML and subordinate documents (i.e., files) stored on the Web that are typically accessible from the same Uniform Resource Locator (URL) and reside on the same server, although such files may be distributed in numerous servers.

Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain. An example of a URL with a HTTP request and domain is: http://www.companyname.com. In this example, the “http” identifies the URL as a HTTP request and the “companyname.com” is the domain.

Domains are much easier to remember and use than their corresponding IP addresses. The Internet Corporation for Assigned Names and Numbers (ICANN) approves some Generic Top-Level Domains (gTLD) and delegates the administrative responsibility to a particular organization (a “registry”) for maintaining an authoritative source for the registered domains within a TLD and their corresponding IP addresses. Such a registry may comprise any registry or other entity under contract (or other agreement) with ICANN to administer one or more TLDs, a registry operator that may comprise any entity sub-contracted with the registry to administer the TLD on behalf of the registry and make the TLD available to registrars for registration, and/or any agent operating on behalf of a registry to carry out the registries' contractual obligations with ICANN. For certain TLDs (e.g., .biz, .info, .name, and .org) the registry is also the authoritative source for contact information related to the domain and is referred to as a “thick” registry. For other TLDs (e.g., .com and .net) only the domain, registrar identification, and name server information is stored within the registry, and a registrar is the authoritative source for the contact information related to the domain. Such registries are referred to as “thin” registries. Most gTLDs are organized through a central domain Shared Registration System (SRS) based on their TLD.

The process for registering a domain with .com, .net, .org, or other TLDs allows an Internet user to use an ICANN-accredited registrar to register their domain. For example, if an Internet user, John Doe, wishes to register the domain “mycompany.com,” John Doe may initially determine whether the desired domain is available by contacting a domain registrar. The Internet user may make this contact using the registrar's website and typing the desired domain into a field on the registrar's webpage created for this purpose.

Upon receiving the request from the Internet user, the registrar may ascertain whether “mycompany.com” has already been registered by checking the SRS database associated with the TLD of the domain. The results of the search then may be displayed on the registrar's website to thereby notify the Internet user of the availability of the domain. If the domain is available, the Internet user may proceed with the registration process. If the domain is not available for registration, the Internet user may keep selecting alternative domains until an available domain is found. When a domain is registered, the registrar may pay a registration fee to the registry responsible for administering the TLD used by the registered domain. Continuing with the previous paragraph's example, upon registration of the domain “mycompany.com,” although the registrar may have collected a fee from the domain registrant, it also may have paid the registry the appropriate registration fee for the allocated .com TLD.

Websites, unless extremely large and complex or have unusual traffic demands, typically reside on a single server and are prepared and maintained by a single individual or entity. Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting servers.

Hosting providers often sell website hosting services based upon the content provider's anticipated memory and bandwidth needs. For example, a content provider may pay a lower monthly fee for 100 gigabytes (GB) of server disk space and 1000 GB of bandwidth than another content provider whose website may require 500 GB and 5000 GB of server disk space and bandwidth, respectively. Content providers must carefully evaluate their website's anticipated storage and bandwidth needs and select their hosting plan accordingly.

Content providers also need to design their websites with security in mind. If not properly designed, the files (and/or databases) that provide the website's functionality may be hacked, and perhaps altered or even overtaken, by unscrupulous or malicious Internet users. For example, some interactive websites may be configured (perhaps by having File Transfer Protocol (FTP) or Web search functionality) to allow users to upload data or files (e.g., photographs, videos, documents, search strings, etc.) to the website, its directories, or databases, thereby exposing the website backend to Internet users.

Such security vulnerabilities may be exploited by many known hacking techniques including SQL injection, Remote File Inclusion (RFI), Local File Inclusion (LFI), or Cross-Site Scripting (XSS). These (and other similar hacking techniques) may cause the uploading of unwanted and potentially malicious files and/or result in the corruption of the files or databases that provide the website's functionality, perhaps rendering the website inoperable.

Similarly, Internet users who access such website content also must keep security in mind. By accessing compromised websites, the Internet user may inadvertently download (perhaps from a hacked hosting server) malware such as viruses, or worms, spyware to their client device (e.g., computer, smartphone, etc.).

Applicant has determined that presently-existing website hosting systems and methods do not provide optimal means for identifying malicious websites, protecting hosting servers against attacks on websites, and/or protecting Internet users from inadvertently downloading malware. Specifically, there is a need for the systems, method for providing a network resource address reputation service described herein.

Systems for Providing an Network Resource Address Reputation Service

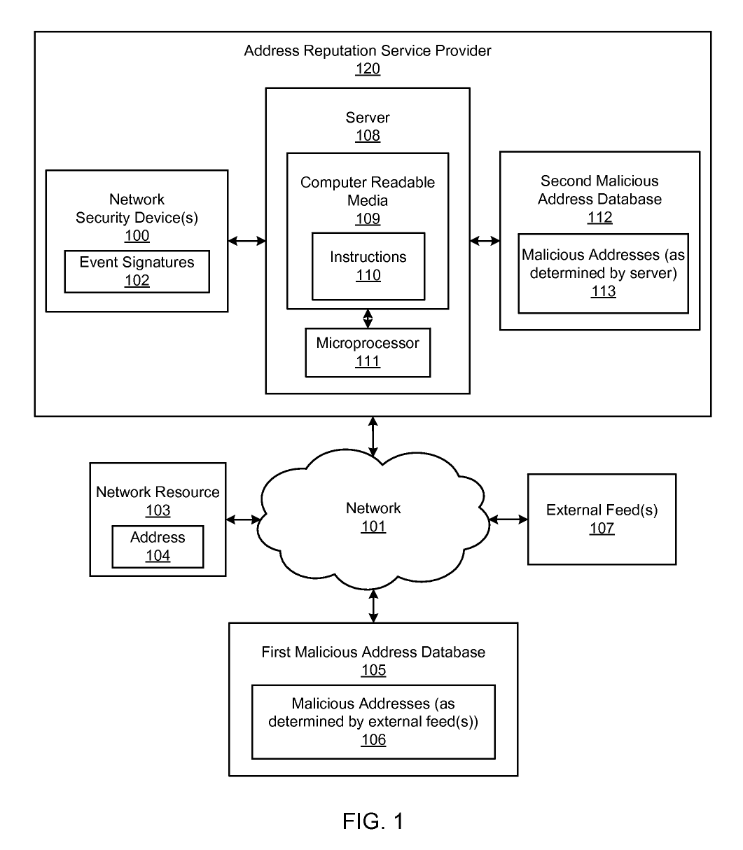

FIG. 1 illustrates an embodiment of a system for providing a network resource address reputation service that may comprise one or more network security device 100 (communicatively coupled to a network 101) storing a plurality of event signatures 102 and being configured to determine whether an event associated with a network resource 103 having a network resource address 104 matches one or more of the plurality of event signatures 102, a first malicious network resource address database 105 (communicatively coupled to the network 101) storing a plurality of malicious network resource addresses 106 determined to be malicious by one or more external feeds 107, and one or more server 108 (communicatively coupled to the network 101) configured to (upon a determination that the event matches one or more of the plurality of event signatures 102) generate a reputation score for the network resource address 104 and determine whether the network resource address 104 is present in the first malicious network resource address database 105. If the network resource address 104 is present in the first malicious network resource address database 105, the one or more server 108 may modify the reputation score to indicate a more negative reputation for the network resource address 104 and store (in a second malicious network resource address database 112 communicatively coupled to the network 101) the network resource address 104 in association with the reputation score.

The example embodiments illustrated herein place no limitation on network 101 configuration or connectivity. Thus, as non-limiting examples, the network 101 could comprise the Internet, the public switched telephone network, the global Telex network, computer networks (e.g., an intranet, an extranet, a local-area network, or a wide-area network), wired networks, wireless networks, or any combination thereof.

System components (e.g., servers 108, network resources 103, external feeds 107, network security devices 100, databases 105 and 112, and/or any other component) may be communicatively coupled to the network 101 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

Network security device(s) 100 may comprise any network 101 security system, software, or appliance that monitors the activity of network-coupled components (e.g., clients, servers, network storage devices, databases, and/or any other network resource) for malicious activity and, perhaps, identify, log information about, block, and/or report such malicious activity. As non-limiting examples, network security devices 100 may comprise a distributed denial of service (DDoS) mitigation device, an intrusion detection system, an intrusion prevention system, or a web application firewall.

In a DDoS attack, numerous compromised systems attack a single target and thereby deny service to users of the targeted system. The multitude of incoming traffic to the targeted system effectively shuts it down (or causes a substantial slowdown), thereby denying access to legitimate users. DDoS attacks often are controlled by a master computer that obtained control of numerous client computers by installing backdoor agent, client, or zombie software on the client computers. A DDoS mitigation device may comprise any system, software, or appliance that detects a potential DDoS attack and blocks related malicious traffic, optimally without affecting the flow of legitimate traffic. As non-limiting examples, the illustrated embodiment may be achieved with either commercially-available (e.g., CISCO GUARD or ARBOR PRAVAIL) or proprietary DDoS mitigation systems.

Intrusion detection may comprise monitoring network use and analyzing it for violations of network security, acceptable use policies, or standard security practices. Intrusion prevention may comprise performing intrusion detection and attempting to stop detected violations. Intrusion detection and prevention systems therefore may comprise any system, software, or appliance that identifies violations, logs related information, attempts to stop violations, and reports violations to security administrators. Any type of intrusion detection and prevention system may be used including, but not limited to Network-based Intrusion Prevention Systems (NIPS), Wireless Intrusion Prevention Systems (WIPS), Network Behavior Analysis (NBA), or Host-based Intrusion Prevention (HIPS) (e.g., installed software that monitors a single host for suspicious activity by analyzing events occurring within that host). As non-limiting examples, the illustrated embodiment may be achieved with either commercially-available (e.g., CISCO INTRUSION DETECTION AND PREVENTION, HEWLETT PACKARD TIPPING POINT, or MCAFEE IPS) or proprietary intrusion detection and prevention systems.

A firewall may comprise any system, software, or appliance that permits or denies network traffic based upon a set of rules. A firewall is commonly used to protect networks from unauthorized access while permitting legitimate traffic. A web application firewall is a network-based application layer firewall that operates at the application layer of a protocol stack. Because it acts on the application layer, it may inspect traffic content and block specified content, such as that originating from malicious websites or software. As non-limiting examples, the illustrated embodiment may be achieved with either commercially-available (e.g., CISCO ACE WEB APPLICATION FIREWALL or BARRACUDA NETWORKS WEB APPLICATION FIREWALL) or proprietary firewall devices.

Network security device(s) 100 may detect malicious activity according to any known detection method including, but not limited to, signature-based, statistical anomaly-based, and stateful protocol analysis methods. As a non-limiting example, a signature-based network security device 100 may store, or otherwise have access to (e.g., stored in another network-coupled storage device), a plurality of event signatures 102 and monitor network 101 traffic for matches to these signatures 102.

Such signature-based network security devices 100 may utilize signatures 102, which are simply known attack patterns. Such systems may intercept network 101 packets and collect a stream of transmitted bytes. The stream then may be analyzed to identify strings of characters in the data, known as signatures 102, which may comprise particular strings that have been discovered in known malicious activity. As a non-limiting example, the signatures 102 may be exploit-based or vulnerability-based. Such signatures 102 may be written, perhaps by a network resource reputation service provider 120, based upon prior known attacks.

As non-limiting examples, event signatures 102 may comprise a plurality of malware signatures including, but not limited to a virus signature, a worm signature, a trojan horse signature, a rootkit signature, a backdoor signature, a spyware signature, a keystroke logger signature, or a phishing application signature.

Alternatively, event signatures 102 may comprise a plurality of attack signatures including, but not limited to one or more signatures identifying a botnet attack, a shell code attack, a cross site scripting attack, a SQL injection attack, a directory reversal attack, a remote code execution attack, a distributed denial of service attack, a brute force attack, a remote file inclusion attack, a script injection attack, or an iFrame injection attack.

Network security device(s) 100 also may be configured (perhaps by installing software and/or scripts on the device 100 containing appropriate instructions) to determine whether an event associated with a network resource 103 having a network resource address 104 matches one or more of the event signatures 102. An “event” may comprise any malicious or unwanted activity, perhaps performed by or via a network resource 103 having a network resource address 104. The network resource 103 may comprise any network 101 coupled device (e.g., a hardware and/or software component) having a network resource address.

As non-limiting examples, the network resource 103 may comprise a server (perhaps hosting a website and/or its content), a client computing device, a database, or any network storage device. The network resource address 104 may comprise any address that identifies a network-coupled component, such as the network resource 103. As non-limiting examples, the network resource address may comprise an IP address, a URL, or a domain (e.g., domain name) for the network resource 103.

As non-limiting examples, the event may comprise any of the incidents described above with respect to event signatures 102. In an example embodiment, the event may be matched with an event signature 102 by intercepting network 101 packets, collecting a stream of transmitted data, analyzing the stream to identify strings of characters in the data, and comparing the identified strings with the event signatures 102. Alternatively, any method of determining an event/event signature 102 match known in the art or developed in the future may be used.

The illustrated embodiment also may comprise a first malicious network resource address database 105 (communicatively coupled to the network 101) storing a plurality of malicious network resource addresses 106 determined to be malicious by one or more external feeds 107. As non-limiting examples, the database 105 (and/or any other database described herein) may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future.

The plurality of malicious network resource addresses 106 stored it the first malicious network resource address database 105 may comprise any network resource address determined to be associated with any malicious or unwanted activity, such as those listed in detail above, by one or more external feeds 107. As non-limiting examples the external feeds 107 may comprise third-party network security services that transmit, perhaps to subscribers, data identifying one or more network resource addresses that have been associated with any malicious or unwanted activity. An external feed 107 may comprise a malware domain list feed, a malware URL list feed, an emerging threat feed, an intrusion detection feed, a botnet tracking feed, a phishing tracking feed, a spam tracking feed, or a compromised network feed. INTERNET STORM CENTER DSHIELD, ZEUS TRACKER, TEAM CYMRU, ARBOR NETWORKS ACTIVE THREAT FEED SECURITY SERVICE, PHISHTANK, and SPAMHAUS all comprise example external feeds 107 that may be used with the illustrated embodiments.

The illustrated embodiment also may comprise one or more server 108 (communicatively coupled to the network 101) configured to (upon a determination that the event matches one or more of the plurality of event signatures 102) generate a reputation score for the network resource address 104. Each of the at least one servers 108 (and/or any other server described herein) could be any computer or program that provides services to other computers, programs, or users either in the same computer or over a computer network 101. As non-limiting examples, the one of more server 108 could be application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, or any combination thereof).

As further illustrated in FIG. 1, the server 108 may comprise a computer-readable storage media 109 storing instructions 110 that, when executed by a microprocessor 111, cause the server 108 to perform the steps for which it is configured. The computer-readable media 109 may comprise any data storage medium capable of storing instructions 110 for execution by a computing device. It may comprise, as non-limiting examples, magnetic, optical, semiconductor, paper, or any other data storage media, a database or other network storage device, hard disk drives, portable disks, CD-ROM, DVD, RAM, ROM, flash memory, and/or holographic data storage. The instructions 110 may, as non-limiting examples, comprise software and/or scripts stored in the computer-readable media 109 that may be stored locally in the server 108 or, alternatively, in a highly-distributed format in a plurality of computer-readable media 109 accessible via the network 101, perhaps via a grid or cloud-computing environment.

As a non-limiting example, the server 108 may be configured to generate a reputation score for the network resource address 104 by having instructions 110 installed in computer readable media 109 causing the microprocessor 111 to generate such a reputation score. The reputation score may comprise any score indicating the reputation for the network resource address 104 and may comprise any rating or ranking scale known in the art or developed in the future. As non-limiting examples, the link match score may range from 0 to 1, 1 to 10, 0% to 100%, and/or A+ to F− (e.g., grades). Alternatively, it may comprise a star rating system or a color rating system (e.g., red indicates a poor reputation, yellow indicates an average reputation, and green indicates a good reputation).

As one non-limiting example, the range for reputation scores may have a minimum value of 0% and a maximum value of 100%, and may indicate a transition from a negative to a positive reputation when the score exceeds a score 50%. The server 108 may calculate such a reputation score, perhaps by determining a quantity of event signature 102 matches associated with each of a plurality of network resource addresses, determining a quantity of event signature 102 matches associated with the subject network resource's 103 network resource address 104, determining a percentage of the plurality of network resource addresses having a quantity of event signature 102 matches that are higher than the quantity of event signature 102 matches associated with the subject network resource's 103 network resource address 104, and assigning that percentage as the reputation score.

For example, the server 108 may determine that IP address A has 0 signature matches, IP address B has 10 signature matches, IP address C has 20 signature matches, and IP address D has 30 signature matches. If the subject network resource's 103 IP address 104 is determined to have 25 signature matches, then only 25% of the IP addresses would have a higher score than the subject IP address 104. A 25% reputation score then may be assigned to the subject IP address 104, indicating a relatively low quality reputation.

In yet another example embodiment, the server 108 may calculate the reputation score, perhaps by determining a quantity of event signature 102 matches associated with each of a plurality of network resource addresses (wherein the plurality of network resource addresses includes the network resource address 104), sequencing each of the plurality of network resource addresses according to the quantity of event signature 102 matches associated with each network resource address, grouping the quantity of event signature 102 matches according to a common quantity of event signature 102 matches, generating a rolling count for each grouping of the common quantity of event signature 102 matches, assigning a percentile score to each of the quantity of event signature 102 matches according to the rolling count, and assigning the percentile score assigned to the quantity of event signature 102 matches associated with the network resource address as the reputation score for the network resource address 104.

For example, the server 108 may determine that IP address A has 125 signature matches, IP address B has 5 signature matches, IP address C has 5 signature matches, IP address D has 1400 signature matches, and IP address E has 110000 signature matches. The IP addresses then may be sequenced amongst each other according to the quantity of event signature 102 matches associated with each IP addresses, perhaps as follows:

| | No. of Event |
|---|---|
| IP Address | Signature Matches |
| IP Address B | 5 |
| IP Address C | 5 |
| IP Address A | 125 |
| IP Address D | 1400 |
| IP Address E | 110000 |

The quantities of event signature 102 matches then may be grouped according to a common quantity of event signature 102 matches, perhaps as follows:

| No. of Matches | No. of Occurrences |
|---|---|
| 5 | 2 |
| 125 | 1 |
| 1400 | 1 |
| 110000 | 1 |

A rolling count for each grouping of common quantity of event signature 102 matches then may be generated, perhaps as follows:

| No. of Matches | No. of Occurrences | Rolling Count |
|---|---|---|
| 5 | 2 | 2 |
| 125 | 1 | 3 |
| 1400 | 1 | 4 |
| 110000 | 1 | 5 |

A percentile score then may be assigned to each quantity of event signature 102 matches according to the rolling count, perhaps as follows:

| | No. of | Rolling | |
|---|---|---|---|
| No. of Matches | Occurrences | Count | Percentile Score |
| 5 | 2 | 2 | 40% = (2/5)*100 |
| 125 | 1 | 3 | 60% = (3/5)*100 |
| 1400 | 1 | 4 | 80% = (4/5)*100 |
| 110000 | 1 | 5 | 100% = (5/5)*100 |

These percentile scores then may be assigned as reputation scores to the associated IP addresses. In the above example, therefore, IP addresses B and C would be assigned a 40% reputation score. The reputation scores for IP addresses A, D, and E would be 60%, 80%, and 100%, respectively, with IP addresses B and C having the best reputation and IP address E having the worst.

In addition to generating a reputation score for the network resource address 104, the server 108 also may determine whether the network resource address 104 is present in the first malicious network resource address database 105, perhaps by submitting a search query comprising the network resource address 104 to the first malicious network resource address database 105. A determination that the network resource address 104 is present among the plurality of malicious network resource addresses 106 (as determined to be malicious by the external feed(s) 107 described above) stored in the first malicious network resource address database 105 comprises additional information indicating a poor reputation for the network resource address 104. Accordingly, the network resource addresses' 104 reputation score may be modified to indicate a more negative reputation.

For example, in the above example wherein 100% represents the best reputation score and 0% the worst, the reputation score may be adjusted toward 0% by a predetermined percentage (e.g., a 10% reduction) if the network resource address 104 is found in the first malicious network resource address database 105. Alternatively, in the above example wherein 0% represents the best reputation score and 100% the worst, the reputation score may be adjusted toward 100% by a predetermined percentage (e.g., a 10% increase) if the network resource address 104 is found in the first malicious network resource address database 105.

The system illustrated in FIG. 1 further may comprise a second malicious network resource address database 112 being communicatively coupled to the network 101. Once the server 108 has calculated the reputation score for the network resource address 104, both the network resource address 104 and its reputation score may be stored in the second malicious network resource address database 112, perhaps among a plurality of malicious network resource addresses 113 and their associated reputation scores as determined by the server 108. This illustrated embodiment may provide the network resource reputation service provider 120 with a collection of network resource address reputation data that may be used, perhaps, to determine whether to connect to a network resource address present in the second malicious network resource address database 112.

The server 108 also may be configured to determine whether the network resource addresses' 104 reputation score exceeds a predetermined value and, if so, add the network resource address 104 to a blacklist, perhaps stored in the second malicious network resource address database 112 or any other network storage device or computer memory communicatively coupled to the network 101. For example, if the predetermined value is 50%, any network resource address having a reputation score worse than 50% may be added to the blacklist, perhaps resulting in blocking connection to—or otherwise precluding communication with—that network resource address.

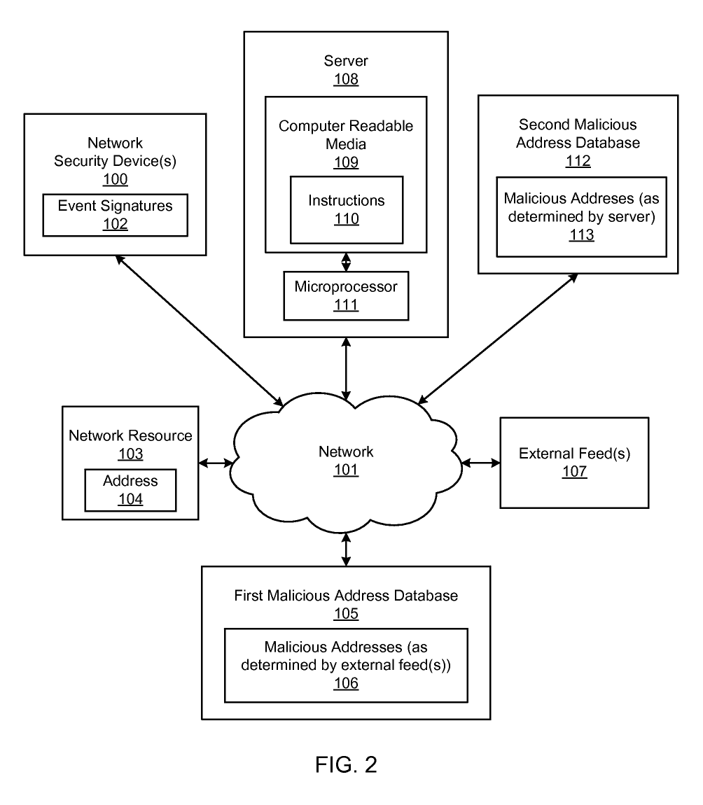

FIG. 2 illustrates an alternate, highly-distributed embodiment of a system for providing a network resource address reputation service, wherein the network resource reputation service provider's 120 internal system components (network security device(s) 100, server(s) 108, and/or second malicious network resource address database(s) 112) may comprise independent, distributed, and standalone systems, each perhaps running on one of more different or geographically-disparate servers coupled to the network 101.

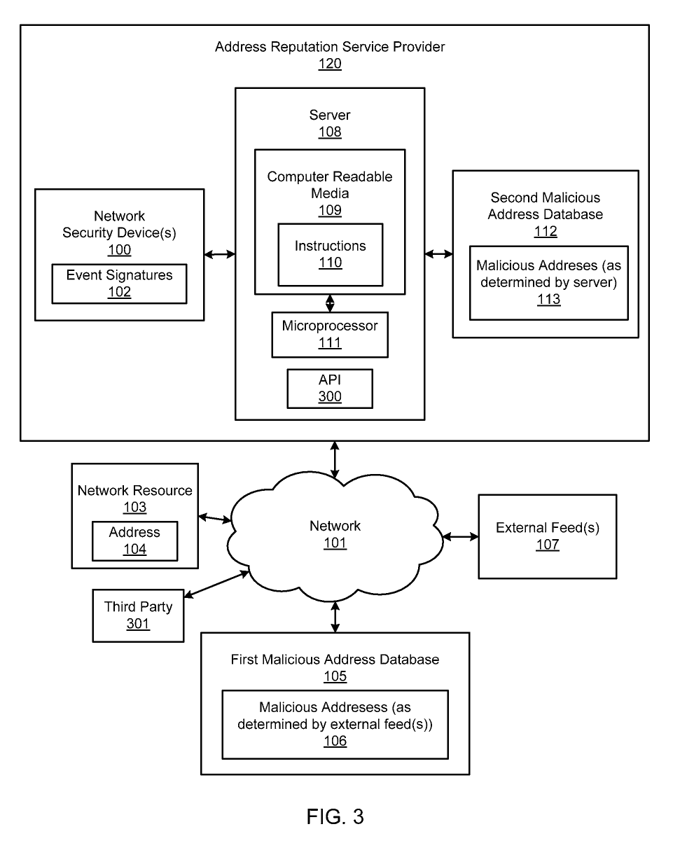

As illustrated in FIG. 3, the network resource reputation service provider 120 may make the data stored in the second malicious network resource address database 112 available to third parties 301, perhaps via an applications programming interface (API) 300 running on one or more of the network resource reputation service provider's 120 servers 108 or the second malicious network resource database 112. Third parties 301 may comprise any individual, entity, system, hardware, or software wishing to obtain reputation data regarding network resource addresses including, but not limited to, Internet users, website hosting providers, web browsers, network security providers, or corporate, governmental, or educational institution MIS managers. An API 300 via which third parties 301 may receive such data may comprise computer-readable code that, when executed, causes the API 300 to receive a procedure call (i.e., function call) requesting network resource reputation data. Responsive to receipt of the procedure call, the API 300 may transmit the requested data to the requesting third party 301.

The API 300 may comprise a software-to-software interface that specifies the protocol defining how independent computer programs interact or communicate with each other. The API 300 may allow the network resource reputation service provider's 120 software to communicate and interact with third parties 301—perhaps over the network 101—through a series of function calls (requests for services). It may comprise an interface running on a server 108 or database 112 that supports function calls made of the described inventions by other computer programs. The API 300 may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

Methods of Providing an IP Address Reputation Service

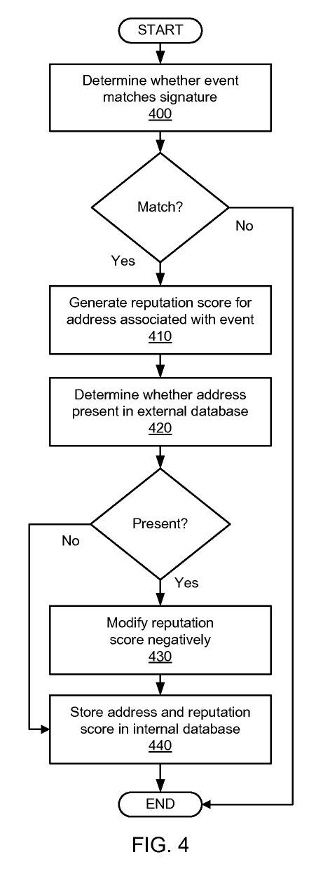

As a non-limiting example, the method illustrated in FIG. 4 (and all methods described herein) may be performed by (at least) any central processing unit (CPU) in one or more computing devices or systems, such as a microprocessor 111 running on a server 108 communicatively coupled to a network 101 (e.g., the Internet) and executing instructions 110 stored (perhaps as scripts and/or software) in computer-readable media accessible to the CPU, such as a hard disk drive or solid-state memory on a server 108. Example systems that may be used to perform the methods described herein are illustrated in FIGS. 1-3 and described in detail above.

FIG. 4 illustrates an embodiment of a method of providing a network resource address reputation service that may comprise determining whether an event associated with a network resource address 104 matches one or more of a plurality of event signatures 102 in one or more network security device 100 (Step 400). As non-limiting examples, Step 400 may be accomplished by the network security device(s) 100, server(s) 108, or external feed(s) 107 as described in detail above. The quantity of event signature 102 matches may be determined (Step 400) over a predetermined period of time, perhaps hourly, daily, or weekly. The predetermined period of time may remain consistent, or it may vary.

Responsive to a determination that the event associated with the network resource address 104 matches an event signature(s) 102, the illustrated method further may comprise generating a reputation score for the network resource address 104 (Step 410). As a non-limiting example, this step may be accomplished by a server 108 configured to generate a reputation score for the network resource address 104 by having instructions 110 installed in computer readable media 109 causing the microprocessor 111 to generate such a reputation score. The reputation score may comprise any score indicating the reputation for the network resource address 104 and may comprise any rating or ranking scale known in the art or developed in the future. As non-limiting examples, the link match score may range from 0 to 1, 1 to 10, 0% to 100%, and/or A+ to F− (e.g., grades). Alternatively, it may comprise a star rating system or a color rating system (e.g., red indicates a poor reputation, yellow indicates an average reputation, and green indicates a good reputation).

The server 108 then may determine whether the network resource address 104 is present in a first malicious network resource address database 105 (Step 420), perhaps by submitting a search query comprising the network resource address 104 to the first malicious network resource address database 105. Responsive to a determination that the network resource address 104 is not present in the first malicious network resource address database 105, the method may comprise storing, in a second malicious network resource address database 112, the network resource address 104 in association with its reputation score (Step 440).

Responsive to a determination that the network resource address 104 is present in said first malicious network resource address database 105, the illustrated method further may comprise modifying the reputation score to indicate a more negative reputation for the network resource address 104 (Step 430). For example, in the above example wherein 100% represents the best reputation score and 0% the worst, the reputation score may be adjusted toward 0% by a predetermined percentage (e.g., a 10% reduction) if the network resource address 104 is found in the first malicious network resource address database 105. Alternatively, in the above example wherein 0% represents the best reputation score and 100% the worst, the reputation score may be adjusted toward 100% by a predetermined percentage (e.g., a 10% increase) if the network resource address 104 is found in the first malicious network resource address database 105. The modified reputation score then may be stored (perhaps in the second malicious network resource address database 112) in association with the network resource address 104 (Step 440).

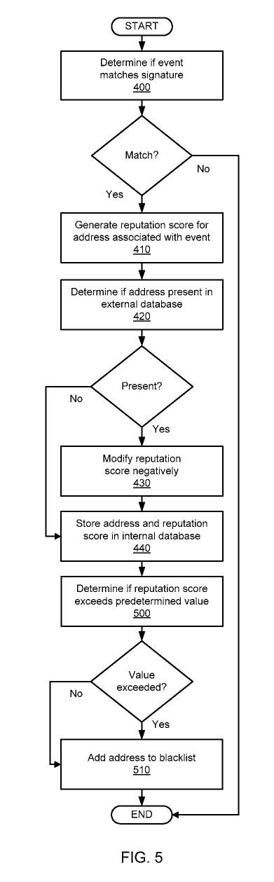

FIG. 5 illustrates an alternate embodiment of a method of providing a network resource address reputation service that builds upon that illustrated in FIG. 4 and further may comprise determining whether the network resource addresses' 104 reputation score exceeds a predetermined value (Step 500) and, if so, adding the network resource address 104 to a blacklist (Step 510), perhaps stored in the second malicious network resource address database 112 or any other network storage device or computer memory communicatively coupled to the network 101. For example, if the predetermined value is 50%, any network resource address having a worse reputation score that 50% may be added to the blacklist, perhaps resulting in blocked connection to—or otherwise precluding communication with—that network resource address.

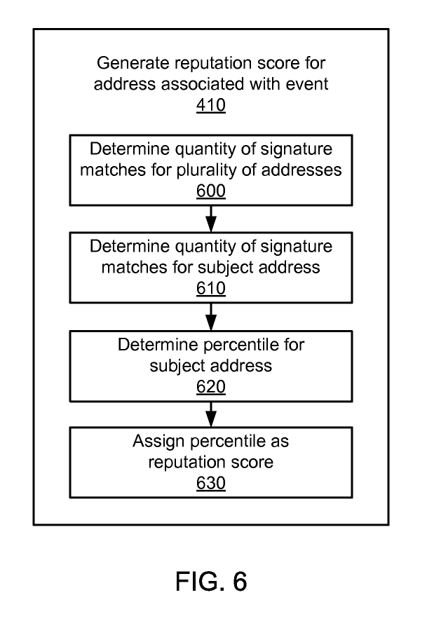

FIG. 6 illustrates a possible embodiment of a method of generating a reputation score for the network resource address 104 (Step 410) that may comprise determining a quantity of event signature 102 matches associated with each of a plurality of network resource addresses (Step 600), determining a quantity of event signature 102 matches associated with the subject network resource's 103 network resource address 104 (Step 610), determining a percentage of the plurality of network resource addresses having a quantity of event signature 102 matches that are higher than the quantity of event signature 102 matches associated with the subject network resource's 103 network resource address 104 (Step 620), and assigning that percentage as the reputation score (Step 630).

For example, the server 108 may determine that IP address A has 0 signature matches, IP address B has 10 signature matches, IP address C has 20 signature matches, and IP address D has 30 signature matches. If the subject network resource's 103 IP address 104 is determined to have 25 signature matches, then only 25% of the IP addresses would have a higher score than the subject IP address 104. A 25% reputation score then may be assigned to the subject IP address 104, indicating a relatively low quality reputation.

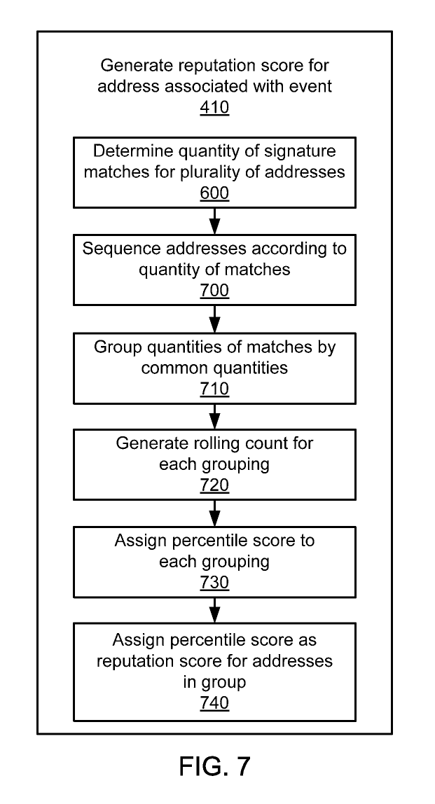

FIG. 7 illustrates a possible embodiment of a method of generating a reputation score for the network resource address 104 (Step 410) that may comprise determining a quantity of event signature 102 matches associated with each of a plurality of network resource addresses (Step 600) (wherein the plurality of network resource addresses includes the network resource address 104), sequencing each of the plurality of network resource addresses according to the quantity of event signature 102 matches associated with each of the plurality of network resource addresses (Step 700), grouping the quantity of event signature 102 matches according to a common quantity of event signature 102 matches (Step 710), generating a rolling count for each grouping of the common quantity of event signature 102 matches (Step 720), assigning a percentile score to each of the quantity of event signature 102 matches associated with each of a plurality of network resource addresses according to the rolling count (Step 730), and assigning the percentile score assigned to the quantity of event signature 102 matches associated with the network resource addresses as the reputation score for the network resource address 104 (Step 740).

For example, the server 108 may determine that IP address A has 125 signature matches, IP address B has 5 signature matches, IP address C has 5 signature matches, IP address D has 1400 signature matches, and IP address E has 110000 signature matches (Step 600). The IP addresses then may be sequenced amongst each of other according to the quantity of event signature 102 matches associated with each IP addresses, perhaps as follows (Step 700):

| | No. of Event |
|---|---|
| IP Address | Signature Matches |
| IP Address B | 5 |
| IP Address C | 5 |
| IP Address A | 125 |
| IP Address D | 1400 |
| IP Address E | 110000 |

The quantities of event signature 102 matches then may be grouped according to a common quantity of event signature 102 matches, perhaps as follows (Step 710):

| No. of Matches | No. of Occurrences |
|---|---|
| 5 | 2 |
| 125 | 1 |
| 1400 | 1 |
| 110000 | 1 |

A rolling count for each grouping of common quantity of event signature 102 matches then may be generated, perhaps as follows (Step 720):

| No. of Matches | No. of Occurrences | Rolling Count |
|---|---|---|
| 5 | 2 | 2 |
| 125 | 1 | 3 |
| 1400 | 1 | 4 |
| 110000 | 1 | 5 |

A percentile score then may be assigned to each quantity of event signature 102 matches according to the rolling count, perhaps as follows (Step 730):

| | No. of | Rolling | |
|---|---|---|---|
| No. of Matches | Occurrences | Count | Percentile Score |
| 5 | 2 | 2 | 40% = (2/5)*100 |
| 125 | 1 | 3 | 60% = (3/5)*100 |
| 1400 | 1 | 4 | 80% = (4/5)*100 |
| 110000 | 1 | 5 | 100% = (5/5)*100 |

These percentile scores then may be assigned as reputation scores to the associated network resource addresses (Step 740). In the above example, therefore, IP addresses B and C would be assigned a 40% reputation score. The reputation scores for IP addresses A, D, and E would be 60%, 80%, and 100%, respectively, with IP addresses B and C having the best reputation and IP address E having the worst.

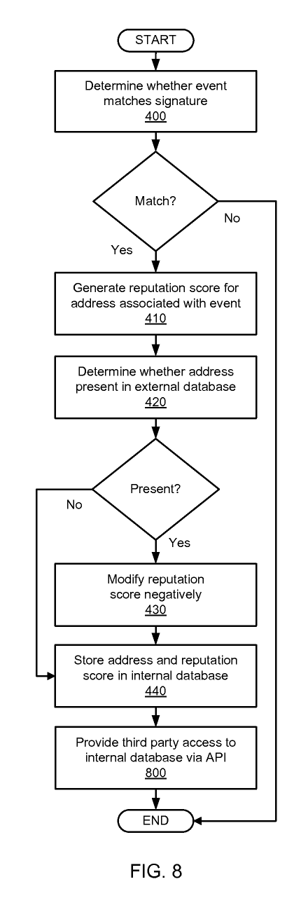

FIG. 8 illustrates an alternate embodiment of a method of providing a network resource address reputation service that builds upon that illustrated in FIG. 4 and further may comprise providing a plurality of third parties 301 access to the second malicious network resource address database 112 via an applications programming interface 300 (Step 800), perhaps as described above with respect to FIG. 3. Such an embodiment may enable a network resource reputation service provider 120 to provide network resource reputation data as a service to third parties 301 wishing to obtain reputation data regarding network resource addresses including, but not limited to, Internet users, website hosting providers, web browsers, network security providers, or corporate, governmental, or educational institution MIS managers. Such a service may be provided, perhaps on a subscription basis.

Systems Providing Bi-Directional Network Traffic Malware Detection and Removal

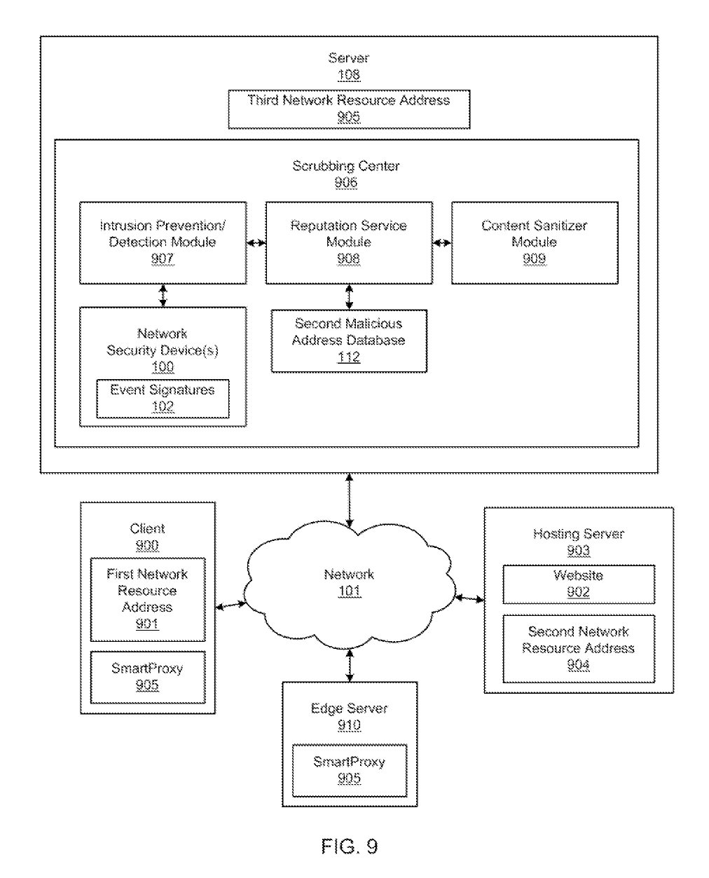

FIG. 9 illustrates an embodiment of a bi-directional network traffic malware detection and removal system that may comprise one or more server 108 (having a third network resource address 905) communicatively coupled to a network 101. As described in detail above with respect to FIG. 1, the server 108 may comprise a computer-readable storage media 109 storing instructions 110 that, when executed by a microprocessor 111, cause the server 108 to perform the steps for which it is configured. The server's 108 third network resource address 905 (and/or all network resource addresses described herein) may comprise, as non-limiting examples, any address that identifies a network-coupled component, such as the server 108. As non-limiting examples, the network resource address 905 (and/or any network resource address described herein) may comprise an IP address (perhaps an IPv4 or IPv6 address), a URL, or a domain (e.g., domain name) for such a network resource.

The server 108 may be configured (perhaps by installing software and or scripts causing the server 108 to perform the steps for which it is configured) to receive (perhaps from a client 900 having a first network resource address 901) a request for content from a website 902, perhaps resolving from a domain name and hosted on one or more hosting server 903 having a second network resource address 904.

The website 902 may comprise any collection of data and/or files accessible to a client 900 or server 108 communicatively coupled to the network 101. As a non-limiting example, the website 902 may comprise a single webpage or multiple interconnected and related webpages, perhaps resolving from a domain name, each of which may provide access to static, dynamic, multimedia, or any other content, perhaps by accessing files (e.g., text, audio, video, graphics, executable, HTML, eXtensible Markup Language (XML), Active Server Pages (ASP), Hypertext Preprocessor (PHP), Flash files, server-side scripting, etc.) that enable the website 902 to display when rendered by a browser on a client 900.

Stored files may be organized in a hosting server's 903 filesystem, which may organize the files for the storage, organization, manipulation, and retrieval by the hosting server's 903 operating system. A hosting server's 903 filesystem may comprise at least one directory, which in turn may comprise at least one folder in which files may be stored. In most operating systems, files may be stored in a root directory, sub-directories, folders, or sub-folders within the filesystem. The one or more hosting server 903 may comprise any network 101-coupled computing device that may host the website 902 (possibly a shared hosting server, a virtual dedicated hosting server, a dedicated hosting server, or any combination thereof).

The requesting client 900 may comprise, as a non-limiting example, a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

The content request may be received by any method, system, or protocol for receiving data, perhaps via an electronic communication received at the server 108 including, but not limited to, a Hyper Text Transfer Protocol (HTTP) or a File Transfer Protocol (FTP) transmission, an email message, and/or a Short Message Service (SMS) message (i.e., text message). As a specific non-limiting example, the content request may be received via HTTP protocol, the request perhaps being initiated by the client's 900 browser.

To direct incoming website 902 traffic to a scrubbing center 906 running on the server(s) 108, the website's 902 domain name may be pointed in the DNS to the server's 108 third network resource address 905, perhaps by updating the domain name's A-record in the DNS zone file with the third network resource address 905.

The scrubbing center 906 may comprise a plurality of software modules running on the one or more server 108, and may comprise an intrusion prevention and detection module 907, a reputation service module 908, and/or a content sanitizer module 909. Each module may comprise software and or scripts containing instructions that, when executed by the server(s) 108, cause the server 108 to perform the steps for which the module is configured via programming.

The intrusion prevention and detection module 907 may be configured to determine whether an event associated with the client's 900 first network resource address 901 matches one or more of a plurality of event signatures 102 in one or more network security device 100 communicatively coupled to the network 101. The intrusion prevention and detection module 907 may be configured (e.g., programmed) to monitor network 101 use for violations of network security, acceptable use policies, or standard security practices. It also may be configured (e.g., programmed) to perform intrusion detection and attempt to stop detected violations. Systems and methods for using network security device(s) 100 and event signatures 102 are described in detail above.

The intrusion prevention and detection module 907 therefore may comprise any system, software, or appliance that identifies violations, logs related information, attempts to stop violations, and/or reports violations, perhaps to network 101 administrators. Any type of intrusion detection and prevention system may be used including, but not limited to Network-based Intrusion Prevention Systems (NIPS), Wireless Intrusion Prevention Systems (WIPS), Network Behavior Analysis (NBA), or Host-based Intrusion Prevention (HIPS) (e.g., installed software that monitors a single host for suspicious activity by analyzing events occurring within that host). As non-limiting examples, the illustrated embodiment may be achieved with either commercially-available (e.g., CISCO INTRUSION DETECTION AND PREVENTION, HEWLETT PACKARD TIPPING POINT, or MCAFEE IPS) or proprietary intrusion detection and prevention systems.

Responsive to a determination that an event associated with the client's 900 first network resource address 901 matches one or more of the plurality of event signatures 102, the intrusion prevention and detection module 907 may block the request for content from reaching the hosting server 903, or transmit the request for content to the content sanitizer module 909.

The reputation service module 908 may be implemented with the systems and methods for providing a network resource address reputation service as described above and illustrated in FIGS. 1-8. As a non-limiting example, the reputation service module 908 may be configured to generate a second malicious network resource address database 112 and determine whether the client's 900 first network resource address 901 is stored in the second malicious network resource address database 112. If so, the reputation service module 908 may transmit a response to the client 900 indicating that its network resource address 901 is stored in the second malicious network resource address database 912. Alternatively, the reputation service module 908 may transmit the content to the content sanitizer module 909.

The content sanitizer module 909 may be configured (e.g., programmed) to determine (or receive a determination from other system modules or components) whether the request for the content (e.g., a HTTP request from the client 900) comprises a server-directed malware (e.g., a botnet, a shell code, a cross site scripting, a SQL injection, a directory reversal, a remote code execution attack, a distributed denial of service attack, or a brute force attack). As one non-limiting example, the content sanitizer module 909 may determine the presence of server-directed malware by receiving notification of the presence of malware from the intrusion detection and prevention module 907. Alternatively, the content sanitizer module 909 may itself be programmed to identify incoming malware, perhaps by comparing them against a plurality of attack or event signatures 102.

Responsive to a determination that the content request comprises server-directed malware, the content sanitizer module 909 may remove the server-directed malware from the request for content, or perhaps block the request from reaching the hosting server 903. As a non-limiting example, if the reputation service module 908 identifies the first network resource address 901 as associated with a brute force attacker, the content request may be blocked from reaching the hosting server 903. In another example, if the intrusion detection and prevention module 907 identifies shell code (or any other server-directed malware) in the content request, the content sanitizer module 909 may either block the request or extract the shell code from the request (perhaps by deleting the code containing the malware from the content request). After the malware has been removed, the content sanitizer module 909 may transmit a “scrubbed” content request (e.g., the request for the content having the server-directed malware removed) to the hosting server 903.

The content sanitizer module 909 also may be configured (e.g., programmed) to determine (or receive a determination from other system modules or components) whether the content transmitted by the hosting server 903 (perhaps responsive to receiving the content request) comprises a client-directed malware (e.g., a virus, a worm, a trojan horse, a rootkit, a backdoor, a spyware, a keystroke logger, a phishing application, a script injection, or an iFrame injection). As one non-limiting example, the content sanitizer module 909 may determine the presence of client-directed malware by receiving notification of the presence of malware from the intrusion detection and prevention module 907. Alternatively, the content sanitizer module 909 may itself be programmed to identify incoming malware, perhaps by comparing them against a plurality of attack or event signatures 102.

Responsive to a determination that the content comprises a client-directed malware, the content sanitizer module 909 may remove the client-directed malware from the content, or perhaps block the response from reaching the client 900. As a non-limiting example, if the reputation service module 908 identifies the hosting server's 903 network resource address 904 as associated with a known virus, the content may be blocked from reaching the client 900. In another example, if the intrusion detection and prevention module 907 identifies a link to a known malware website in the content, the content sanitizer module 909 may either block the content or remove the link from the content. After the malware has been removed, the content sanitizer module 909 may transmit a “scrubbed” content (e.g., the content having the client-directed malware removed) to the client 900.

In another possible embodiment, a SmartProxy 905 may be used to divert traffic though the scrubbing center 906. The SmartProxy 905 may comprise a proxy server application, software, or script that may run on an Internet user's client 900, or perhaps on the network edge. The SmartProxy 905 may communicate directly to the scrubbing center 906. The SmartProxy 905 may act as an intermediary between the client 900 or edge server 910 and the hosting server 903. In one embodiment, the SmartProxy 905 may comprise an application, perhaps downloaded to the client 900 or edge server 910 from a scrubbing center 906 service provider, that ensures all traffic from and/or to the client 900 is routed to, and filtered through, the scrubbing center 906.

As a non-limiting example, the SmartProxy 905 may be configured (e.g., programmed) to receive website 902 content requests from the client 900 and redirect such requests to the scrubbing center 906. As a non-limiting example, the SmartProxy may accomplish this by storing the website 902 hosting server's 903 second network address 904 (e.g., IP address) in association with the scrubbing center 906 server's 108 third network resource address (e.g., IP address), along with instructions to route requests for the website 902 to the scrubbing center 906.

When website 902 content is returned to the client 900, it may be redirected to the scrubbing center 906 to ensure that, for example, any client-directed malware is removed. Where the client 900 initiates the content request, the returned website 902 content may automatically be redirected to the scrubbing center 906. Where the hosting server 903 initiates a connection with the client 900, the SmartProxy 905 may intercept and redirect the traffic to the scrubbing center 906. As a non-limiting example, the SmartProxy may accomplish this by storing the scrubbing center 906 server's 108 third network resource address (e.g., IP address), along with instructions to route all incoming traffic to the scrubbing center 906 and request that the scrubbing center 906 return scrubbed content to the SmartProxy 905.

Methods of Bi-Directional Network Traffic Malware Detection and Removal

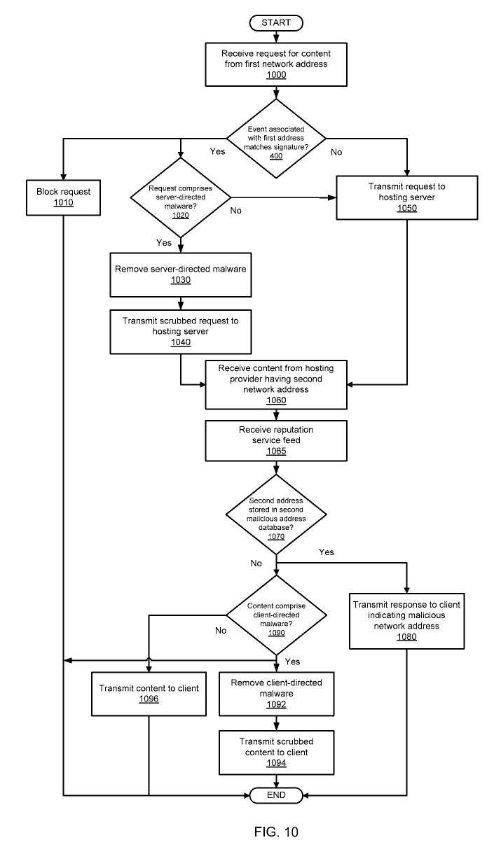

FIG. 10 illustrates an embodiment of a method for bi-directional detection and removal of network traffic malware that may comprise the steps of receiving, from a client 900 having a first network resource address 901, a request for content from a website 902 hosted on a hosting server 903 having a second network resource address 904 and resolving from a URL such as domain name, wherein the URL (e.g., domain name) is pointed in the DNS to a third network resource address 905 for one or more server 108 running a scrubbing center 906 (Step 1000).

The content request may be received (Step 1000) by any method, system, or protocol for receiving data, perhaps via an electronic communication received at the server 108 including, but not limited to, a Hyper Text Transfer Protocol (HTTP) or a File Transfer Protocol (FTP) transmission, an email message, and/or a Short Message Service (SMS) message (i.e., text message). As a specific non-limiting example, the content request may be received via HTTP protocol, the request perhaps being initiated by the client's 900 browser.

The illustrated method further may comprise the step of determining whether an event associated with the client 900 or its first network resource address 901 matches one or more of a plurality of event signatures 102 in one or more network security device 100 communicatively coupled to the network 101 (Step 400), which may be accomplished as described in detail above. If the event does not match an event signature 102, the request for content may be transmitted, perhaps unaltered, to the hosting server 903 (Step 1050).

But if the event matches one or more event signature 102, the method further may comprise blocking the request for content from reaching the hosting server 903 (Step 1010). As one non-limiting example, the content request may be blocked and a HTTP 404 error code may be transmitted back to the requesting client 900. Alternatively, the client 900 may be transmitted a message indicating that it or its IP address (i.e., first network resource address 901) have been associated with an event.

Alternatively (if an event/event signature match is found), the method further may comprise determining whether the request for content comprises a server-directed malware (e.g., a botnet, a shell code, a cross site scripting, a SQL injection, a directory reversal, a remote code execution attack, a distributed denial of service attack, or a brute force attack) (Step 1020). As one non-limiting example, a content sanitizer module 909 may determine the presence of server-directed malware by receiving notification of the presence of malware from the intrusion detection and prevention module 907. Alternatively, the content sanitizer module 909 may itself be programmed to identify incoming malware, perhaps by comparing them against a plurality of attack or event signatures 102.

Responsive to a determination that the request for content comprises a server-directed malware, the illustrated method further may comprise removing the server-directed malware from the request for content (Step 1030) and transmitting a scrubbed request for content (e.g., the request for content having the server-directed malware removed) to the hosting server 903 (Step 1040). Step 1030 may be accomplished as described in detail above, perhaps by the content sanitizer module 909. If the request for content does not comprise any server-directed malware, the request for content may be transmitted, perhaps unaltered, to the hosting server 903 (Step 1050).

The illustrated method further may comprise the step of receiving the content from the hosting server 903 (Step 1060). In one embodiment, content may be received (perhaps at the server 108 running the scrubbing center 906) after the content is transmitted by the hosting server 903 responsive to receiving the request for content (scrubbed or un-scrubbed) from the server 108.

A reputation feed then may be received (Step 1065), perhaps from a network resource address reputation service provider (e.g., a reputation service module 908) having a second malicious network resource address database 112. The reputation feed may be implemented as described in detail above with respect to the systems and methods for providing a network resource address reputation service.

If it is determined that the hosting server's 903 network resource address 904 is stored in the second malicious network resource address database 112 (Step 1070), a response may be transmitted to the client 900 indicating that the second network resource address 904 is stored in the second malicious network resource address database 112 (Step 1080). As one non-limiting example, the content may be blocked and a HTTP 404 error code may be transmitted back to the requesting client 900. Or the client 900 may be transmitted a message indicating that the hosting server 903 or its IP address (i.e., second network resource address 904) have been associated with a malicious network address.

Alternatively, rather than transmit an error (or content unavailable) message to the client 900, the illustrated method further may comprise determining whether the content comprises a client-directed malware (e.g., a virus, a worm, a trojan horse, a rootkit, a backdoor, a spyware, a keystroke logger, a phishing application, a script injection, or an iFrame injection) (Step 1090) and, if so, removing the client-directed malware from the content (Step 1092) and transmitting a scrubbed content (e.g., website content having the client-directed malware removed) to the client 900 (Step 1094). Steps 1090, 1092, and 1094 may be accomplished, as a non-limiting example, via the content sanitizer module 909 described in detail above. If it is determined that the content does not comprise a client-directed malware, the content may be transmitted (perhaps directly and/or unaltered) to the client 900 (Step 1096).

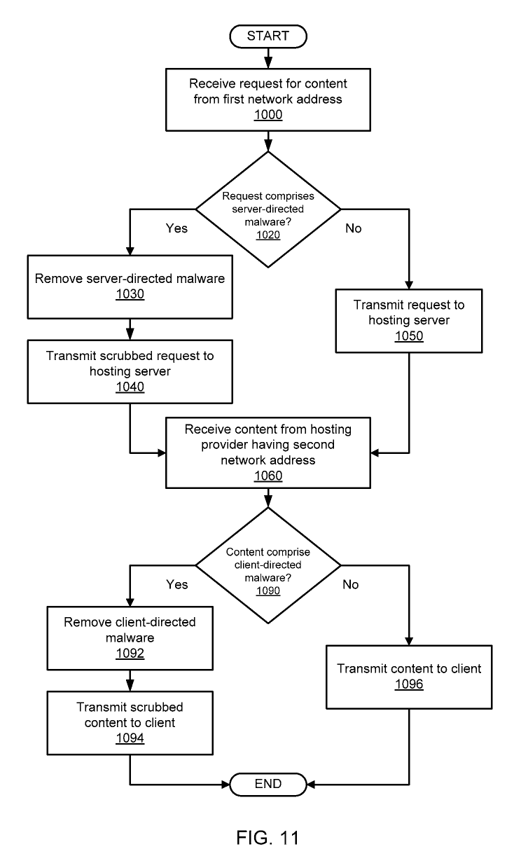

FIG. 11 illustrates an embodiment of a method for bi-directional detection and removal of network traffic malware that may comprise the steps of receiving, from a client 900 having a first network resource address 901, a request for content from a website 902 hosted on a hosting server 903 having a second network resource address 904 and resolving from a domain name, wherein the domain name is pointed in the DNS to a third network resource address 905 for one or more server 108 running a scrubbing center 906 (Step 1000).

The method further may comprise determining whether the request for content comprises a server-directed malware (e.g., a botnet, a shell code, a cross site scripting, a SQL injection, a directory reversal, a remote code execution attack, a distributed denial of service attack, or a brute force attack) (Step 1020). Responsive to a determination that the request for content comprises a server-directed malware, the illustrated method further may comprise removing the server-directed malware from the request for content (Step 1030) and transmitting a scrubbed request for content (e.g., the request for content having the server-directed malware removed) to the hosting server 903 (Step 1040). Step 1030 may be accomplished as described in detail above, perhaps by the content sanitizer module 909. If the request for content does not comprise any server-directed malware, the request for content may be transmitted, perhaps unaltered, to the hosting server 903 (Step 1050).

The illustrated method further may comprise the step of receiving the content from the hosting server 903 (Step 1060). In one embodiment, content may be received (perhaps at the server 108 running the scrubbing center 906) after the content is transmitted by the hosting server 903 responsive to receiving the content request for content.

The illustrated method further may comprise determining whether the content comprises a client-directed malware (e.g., a virus, a worm, a trojan horse, a rootkit, a backdoor, a spyware, a keystroke logger, a phishing application, a script injection, or an iFrame injection) (Step 1090) and, if so, removing the client-directed malware from the content (Step 1092) and transmitting a scrubbed content (e.g., website content having the client-directed malware removed) to the client 900 (Step 1094). Steps 1090, 1092, and 1094 may be accomplished, as a non-limiting example, via the content sanitizer module 909 described in detail above. If it is determined that the content does not comprise a client-directed malware, the content may be transmitted (perhaps directly and/or unaltered) to the client 900 (Step 1096).

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method performed by one or more server computer communicatively coupled to a network, comprising:
A) receiving, from a client having a first network resource address, a request for a content from a website hosted on a hosting server computer having a second network resource address and resolving from a domain name, wherein said domain name is pointed in a DNS to a third network resource address for said one or more server computer;
B) determining whether an event associated with said first network resource address matches one or more of a plurality of event signatures in one or more network security device communicatively coupled to said network;
C) responsive to a determination that said event associated with said first network resource address matches said one or more of a plurality of event signatures:
i) blocking said request for said content from reaching said hosting server; or
iii) determining whether said request for said content comprises a server-directed malware;
a) responsive to a determination that said request for said content comprises a server-directed malware:
I) removing said server-directed malware from said request for said content; and
II) transmitting a scrubbed request for said content to said hosting server computer, said scrubbed request for said content comprising said request for said content having said server-directed malware removed; and
b) responsive to a determination that said request for said content does not comprise a server-directed malware, transmitting said request for said content to said hosting server computer;
D) responsive to a determination that said event associated with said first network resource address does not match said one or more of a plurality of event signatures, transmitting said request for said content to said hosting server computer;
E) receiving said content from said hosting server computer;
F) receiving a feed from a network resource address reputation service provider having a second malicious network resource address database;
G) determining whether said second network resource address is stored in said second malicious network resource address database;
H) responsive to a determination that said second network resource address is stored in said second malicious network resource address database:
i) transmitting a response to said client indicating that said second network resource address is stored in said second malicious network resource address database; or
ii) determining whether said content comprises a client-directed malware;
a) responsive to a determination that said content comprises a client-directed malware:
I) removing said client-directed malware from said content; and
II) transmitting a scrubbed content to said client, said scrubbed content comprising said content having said client-directed malware removed; and
b) responsive to a determination that said content does not comprise a client-directed malware, transmitting said content to said client; and
I) responsive to a determination that said second network resource address is not stored in said second malicious network resource address database, transmitting said content to said client.

2. The method of claim 1, wherein said first network resource address, said second network resource address, or said third network resource address comprise an IP address.

3. The method of claim 2, wherein said IP address comprises an IPv4 or an IPv6 address.

4. The method of claim 1, wherein said one or more network security device comprise a distributed denial of service mitigation device, an intrusion detection system, an intrusion prevention system, or a web application firewall.

5. The method of claim 4, wherein said plurality of event signatures comprise a plurality of attack signatures.

6. The method of claim 5, wherein said plurality of attack signatures comprise one or more signatures identifying a botnet attack, a shell code attack, a cross site scripting attack, a SQL injection attack, a directory reversal attack, a remote code execution attack, a distributed denial of service attack, a brute force attack, a remote file inclusion attack, a script injection attack, or an iFrame injection attack.

7. The method of claim 6, wherein said server-directed malware comprises a botnet, a shell code, a cross site scripting, a SQL injection, a directory reversal, a remote code execution attack, a distributed denial of service attack, or a brute force attack.

8. The method of claim 7, wherein said client-directed malware comprises a virus, a worm, a trojan horse, a rootkit, a backdoor, a spyware, a keystroke logger, a phishing application, a script injection, or an iFrame injection.

9. A method performed by one or more server computer communicatively coupled to a network, comprising:
A) receiving, from a client having a first network resource address, a request for a content from a website hosted on a hosting server computer having a second network resource address and resolving from a domain name, wherein said domain name is pointed in a DNS to a third network resource address for said one or more server computer;
B) determining whether said request for said content comprises a server-directed malware;
C) responsive to a determination that said request for said content comprises a server-directed malware:
i) removing said server-directed malware from said request for said content;
ii) transmitting a scrubbed request for said content to one or more hosting server computer hosting said website, said scrubbed request for said content comprising said request for said content having said server-directed malware removed;
D) responsive to a determination that said request for said content does not comprise a server-directed malware, transmitting said request for said content to said one or more hosting server computer;
E) receiving said content from said one or more hosting server computer;
F) determining whether said content comprises a client-directed malware;
G) responsive to a determination that said content comprises a client-directed malware:
i) removing said client-directed malware from said content; and
ii) transmitting a scrubbed content to said client, said scrubbed content comprising said content having said client-directed malware removed; and
H) responsive to a determination that said content does not comprise a client-directed malware, transmitting said content to said client.

10. The method of claim 9, wherein said first network resource address, said second network resource address, or said third network resource address comprise an IP address.

11. The method of claim 10, wherein said IP address comprises an IPv4 or an IPv6 address.

12. The method of claim 11, wherein said server-directed malware comprises a botnet, a shell code, a cross site scripting, a SQL injection, a directory reversal, a remote code execution attack, a distributed denial of service attack, or a brute force attack.

13. The method of claim 11, wherein said client-directed malware comprises a virus, a worm, a trojan horse, a rootkit, a backdoor, a spyware, a keystroke logger, a phishing application, a script injection, or an iFrame injection.

14. The method of claim 11, wherein steps B) and F) further comprise receiving a feed from a network resource address reputation service provider having a second malicious network resource address database via an applications programming interface.

15. The method of claim 14, wherein determining steps B) and F) further comprise determining whether said first network resource address or said second network resource address are stored in said second malicious network resource address database.

16. The method of claim 15, wherein determining steps B) and F) further comprise determining whether an event associated with said first network resource address or said second network resource address matches one or more of a plurality of event signatures in one or more network security device.

17. The method of claim 16, wherein said one or more network security device comprise a distributed denial of service mitigation device, an intrusion detection system, an intrusion prevention system, or a web application firewall.

18. The method of claim 17, wherein steps C) and G) are accomplished by a content sanitizer running on said one or more server computer.
